(19) United States
(12) Patent Application Publication
(10) Pub. No.: US 2009/0210241 A1
(43) Pub. Date: Aug. 20, 2009

(54) Emergency Contact System that Interfaces with Government ID

(76) Inventor: T. Michael Calloway, Aldie, VA (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/032,355

(22) Filed: Feb. 15, 2008

(51) Int. Cl. G06Q 99/00

(52) U.S. Cl. 705/1

(57) ABSTRACT

A system for identifying and providing emergency contacts and returning lost identification that interfaces with a government-issued ID and provides only member-provided information to properly authenticated users over the internet.

### BACKGROUND

1. Field of the Invention

The present invention relates to a system for identifying and providing an individual's emergency contact. In particular, to a system that interfaces with that individual's government-issued identification.

2. Description of the Related Art

Offerings for identifying and providing an individual's emergency contact exist in the market; however, their individual and collective deficiencies indicate there is an unsatisfied need. In general alternative offerings have a different business focus or service dependencies. Many contain sensitive medical information, represent a static record that readily becomes obsolete, allow for miscommunications, and comprise a smorgasbord of membership ID types, forms, or identification. Such services do not readily put emergency assisting services in direct contact with an informed person. These offerings are expensive for either membership or for the processing of record updates.

Examples of Alternatives:
a. Personally created lists or notes reflecting names and numbers. These memos can suffer from physical deterioration, penmanship bleeding, lack of immediate recognition, information obsolescence, limited content (one or a couple names and one phone number each), and lack of instructions. They must be manually maintained. If they are lost, there is no way to protect information from disclosure.
b. Services providing printed cards or forms: These can suffer from physical deterioration, penmanship bleeding, information obsolescence, limited content (one or a couple names and one phone number each), and lack instructions. They must be manually maintained. If they are lost, there is no way to protect information from disclosure.
c. Services providing credit card compact discs (“CDs”) These services' focus is typically on medical records, allergies, medication, and medical services information such as physician names and numbers. These CDs provide meaningful information but contain a lot of private information not intended for disclosure in the context of a nonemergency Information may become obsolete within hours of recording. Since the CD's are not password protected, there is no way to prevent private medical information discovery if the CD is lost. The purpose of it is to make it available to treating services. There is a time lag for updates; members must provide information and wait for a CD to be mailed. There are additional charges for preparing and shipping updated CDs Their usability is reliant upon emergency aid having access to a device that can read the CD. The person rendering assistance may not readily recognize the purpose of the CD. Some services require the private medical information and emergency contacts information be faxed or mailed to the service provider making them discoverable or subject to wrongful use by a third party, or loss in transit.
d. Services providing membership cards with call center support This service alternative introduces a third party into the communications circle. It allows for inappropriate disclosure of medical information if a unscrupulous caller merely found the ID and seeks to obtain any information available. It also allows for miscommunications or misinterpretation of information on record by inexperienced call center personnel. Call center services add cost to the program. This alternative focuses typically on medical records, medications, and medical services information such as physician names and numbers. Information may become obsolete within hours of recording. Member must interact with a call agent or access a website to process record updates. The program typically attempts to promote additional services to its members. Fundamentally, the Member is not in control of potential use or disclosure of information on file.
e. Services providing flash drives or storage media (bracelets/necklace): This service alternative device focuses typically on medical records, allergies, medication, and medical services information such as physician names and numbers. The purpose of it is to make the information available to treating services. These may provide meaningful information but contain a lot of private personal information not intended for disclosure in an emergency. Information may become obsolete within hours of recording. Depending upon the device, means for updating the member's information may be either restricted or extremely unstructured. Since the media is not password protected, there is no way to prevent private medical information discovery if lost. Their usability is reliant upon emergency aid having access to a device that can read the storage media. The storage media must be present at time of need and recognized by the emergency assisting person
f. Employer emergency contact records: These records are typically limited to one personal emergency contact and are only available during customary working hours of that employer. These records are very limited in content and often outdated. These records are not accessible outside of the employer environment
g. Medical alert devices: These devices focus on obtaining emergency service response at the time of personal need. It is dependant upon being activated, has limited geographic coverage, lacks mobility, and is expensive. This alternative focuses typically on medical records, medication, medical services information such as physician names and numbers. Information may become obsolete within hours of recording. A Member must interact with a call agent or access a website to process record updates. This system allows for miscommunications or misinterpretation of information on record by inexperienced call center personnel.
h. Vehicular monitoring services These services rely on a call center whose focus is detection of an emergency situation while in the confines of a vehicle and initiating appropriate service response Service is limited to vehicle sensor detection or access to the vehicle and service territory coverage. The services are not readily accessible to emergency service provides administration offices. Services are limited, expensive, and not generally available to the mass population

In sum, it is desirable that a system for providing emergency contact information not rely on a call center on call personnel; not require a device for reading the system, not be linked to an object that must be activated or is easily lost, be easily updated; not contain personal information unnecessary to an emergency situation; and be easily updated.

### SUMMARY

Because of these and other problems in the art, disclosed herein is a method for providing contact information in the event of an emergency or lost identification, the method comprising: issuing a government-issued identification card, comprising a government identification number, to an individual for a secondary purpose; said individual enrolling in a registry as a member, said step of enrolling comprising: providing said contact information, further comprising a profile, contact record, and emergency contact record, providing said government identification number, and creating a password; generating a key code associated with said password upon said enrollment; generating a member identification number associated with said government identification number upon said enrollment; displaying said key code on said card; authenticating a user to obtain said member's contact information based on said user's role and said user's correct entry into said registry of said member's key code and information on said card, and providing said contact information to said user

In an embodiment of the method, the step of displaying utilizes a transparent sleeve for the card.

In an embodiment, the enrolling may comprise paying an enrollment fee In a further embodiment, the method further comprises reminding the member to pay the enrollment fee's next installment. The method may alternatively or further comprise reminding the member to update the contact information.

In an embodiment, the information on the card comprises the name of the member, the origin of the card, and the member identification number. In an alternative or further embodiment, the steps of enrolling, generating, authenticating, and providing all use the internet. In an alternative or further embodiment, the card may be a state-issued driver's license or a passport.

In an embodiment, the user is an emergency assisting person, and the contact information in the step of providing is limited to the emergency contact record. In an alternative embodiment, the user is a person reporting lost ID, and wherein the contact information in the step of providing is limited to the contact record. In an alternative embodiment, the user is the member, wherein upon the step of authenticating further comprising entering the password into the registry, the user may update the contact information.

In an embodiment of the method, the contact information comprises a member point of contact.

Also disclosed herein is a system for providing contact information in the event of an emergency or lost identification, the system comprising, a government-issued identification card, comprising a government identification number, coupled to means for providing notification of enrollment in said system; an online registry wherein an individual enrolls by entering a profile, said identification number, contact record, and emergency contact record, and creating a password, and wherein upon said enrollment said registry issues said individual a key code corresponding to said password and a member identification number corresponding to said government identification number; wherein said key code is placed upon said means for providing notification; and wherein a user authenticated by said registry according to said user's role may access said individual's contact information by said key code, said member identification number, the name of said individual on said card, and the origin of said card.

In an embodiment of the system, the registry reminds the individual to update the contact information. In an embodiment, the means for providing notification comprises a transparent sleeve for the card.

In an embodiment of the system, the individual enrolls by further paying an enrollment fee. In a further embodiment, the system reminds the individual to pay the enrollment fee's next installment.

In an embodiment of the system, the registry is on the internet and the enrolling, the authenticating, and the access utilize the internet.

In embodiments, the card maybe a state-issued driver's license or passport.

In an embodiment of the system, the user is an emergency assisting person, and the user may access the individual's contact information limited to the emergency contact record. In an alternative embodiment, the user is a person reporting lost ID, and wherein the user may access the individual's contact information limited to the contact record. In an alternative embodiment, the user is the individual, and the user may use the key code, the information on the card, the member identification number, and the password to access and update the individual's contact information.

In an embodiment of the system, the contact information comprises a member point of contact.

### BRIEF DESCRIPTION OF THE DRAWINGS

FIG. 1 is a diagram of the system's basic architecture and communications flow,

FIG. 2 is a diagram of the system's basic features.

FIG. 3 is a diagram showing the correlation between an official ID# to the NPECR Member ID#.

FIGS. 4a and 4b are diagrams of different aspects of the system's basic logical associations of NPECR processes.

FIGS. 5a and 5b are diagrams of different aspects of the Member Enrollment Process and creation of the Member Profile Record.

FIG. 6 is a flow chart showing the creation of the Member Contact Record

FIG. 7 is a flow chart showing the creation of the Member Emergency Contacts Record.

FIG. 8 is a depiction of process flow for an Emergency Assisting Person making a system query.

FIG. 9 is a depiction of process flow for a Person Reporting a Lost ID making a system query.

FIGS. 10a and 10b are depictions of different bases for system generated Reminder Notices for Record Maintenance.

### DESCRIPTION OF PREFERRED EMBODIMENTS

Disclosed herein is a system for using internet-based and computing technology capabilities, including the Internet, for a more efficient, secure, responsive, and cost effective means to:
1. Provide emergency contact information of a person when said person is unable to effectively communicate with emergency assisting services due to unconsciousness, incoherency, or language barriers.
2. Provide contact information for advising another party of a person with mental dementia or Alzheimer's disease who is lost.
3. Provide key contact information of a person for the returning of a found agency issued identification card such as a state driver's license.
4. Provide a listing of multiple per-sons and multiple communications means for communicating with personal emergency contacts during time of need. In an embodiment, up to five names with three phone numbers and two email addresses each may be posted.
5. Provide real time status of a member's medical condition or wishes via direct communications between emergency assisting services and emergency contacts.
6. Provide contact information continuously worldwide via Internet connectivity.
7. Provide a standardized and readily recognizable Member ID# (by using, for example, state driver's licenses) that also serves as login ID for selected information retrieval.
8. Avoid unauthorized disclosure of medical or other private information by virtue that none is contained in the system. There is no sensitive data to be discovered should an ID, wallet, purse etc. be lost.
9. Allow the member to maintain full control over the information stored. No other party has access to posting or updating a member's record.
10. Allow for immediate record update continuously, and as frequently as needed.
11. Avoid misinterpretation or miscommunicating information by lack of any third party service or agency participation.
12. Serve as a communications enabler between emergency assisting person and an emergency contact, as opposed to a repository of highly sensitive or personal information.
13. Avoid wrongful medical treatment by providing real-time current information to emergency assisting person.
14. Convey member's latest wishes for emergency services and treatment.
15. Coordinate transportation destination actions.

The National Personal Emergency Contacts Registry (NPRCR) is a system and method by which a Member's participation identification relies on an existing and controlled national or state identification media, evokes a standardized means for emergency services personnel immediate recognition of enrollment, and serves as a highly effective communications enabler between an emergency assisting person and designated emergency contacts at time of emergency need. The National Personal Emergency Contacts Registry Systems and methods for, membership recognition, unique Member ID number origin and assignment, system features and characteristics, Member Record separation and unique access control, means for data query/retrieval and all its embodiments herein will be referred to as the NPECR system.

The systems and methods described herein save lives, avoid wrongful treatment, coordinate transportation destination, provide real-time Members conditions and wishes, reduce communication barriers, facilitate return of Member's lost source IDs, and relieve concerned party's anxiety of uncertainty about the circumstances of a Member or their property.

In the NPECR system, individuals who may be referred to herein as “Members” enroll and subscribe to a national web based service that allows them to post names and contact information for emergency notification, as well as a member profile. The Member voluntarily provides this contact information on record. The data on record is fully controlled by the Member. The system permits continuous, authenticated queries to a secure Website. Authorized queries to the Website provide immediate access to posted information such as: contact sequence, names, phone numbers, and email addresses of Member identified parties who should be contacted during a personal emergency when the Member is unable to provide such information or make contact. The contacted individuals may then provide current and relevant detailed information or directives to an Emergency-Assisting-Person in response to the circumstances. The system also provides phone numbers and email addresses of the Member for a Person-Reporting-Lost-ID to make contact and advise of lost ID.

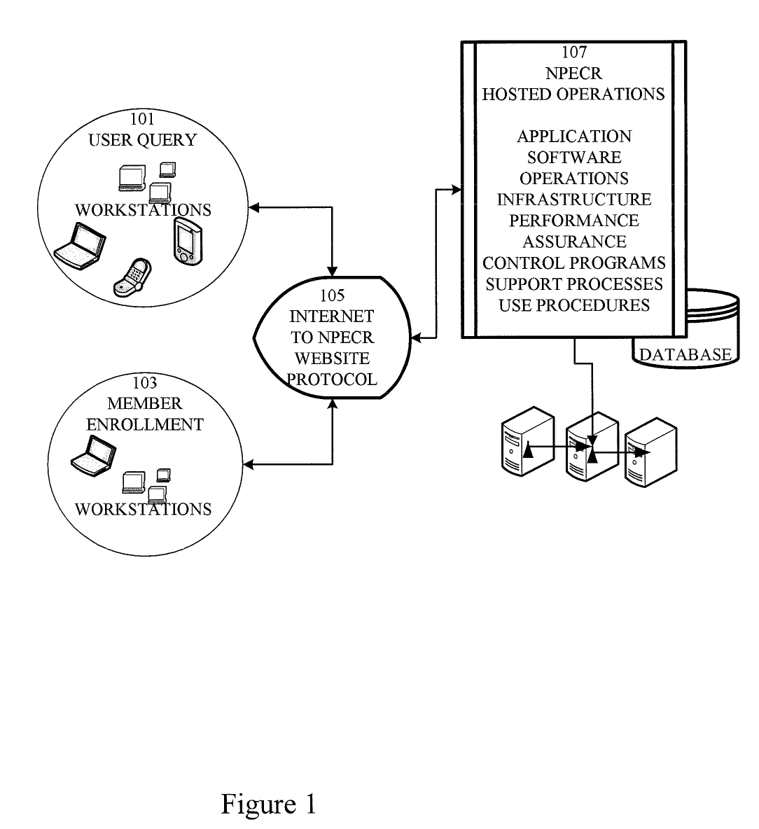

FIG. 1 shows the NPECR system's basic architecture and communications flow. The NPECR system is accessible for User or Member query by any device that may access the internet and has the appropriate combination of read, write, display or print capabilities, such as but not limited to networked or stand alone computer work stations, laptops, cell phones or PDA devices with like capabilities (101). Users would traditionally use networked or stand alone computer workstations or laptops (103) to perform Member enrollment or other Member maintenance services. Changes in technology may avail additional alternatives to either category of user in taking advantage of the NPECR System features. The User or Member connects to the NPECR System website home page via Internet connectivity by either using an Internet key word search or specifically addressing the login to a NPECR website URL domain name (105). The front-end web interface, application software, and database reside on a central hosting server platform (107) providing continuous operability capability, security assurance, with redundancy or fail-over considerations. The communications interface, web pages, application software, software use licenses, database, servers, peripheral equipment, facility infrastructure, performance governance safeguards, and operational programs, processes, and procedures collectively represent the aspects of the NPECR System that collects and distributes information. The NPECR System may be elaborated and modified over time as relevant technology changes.

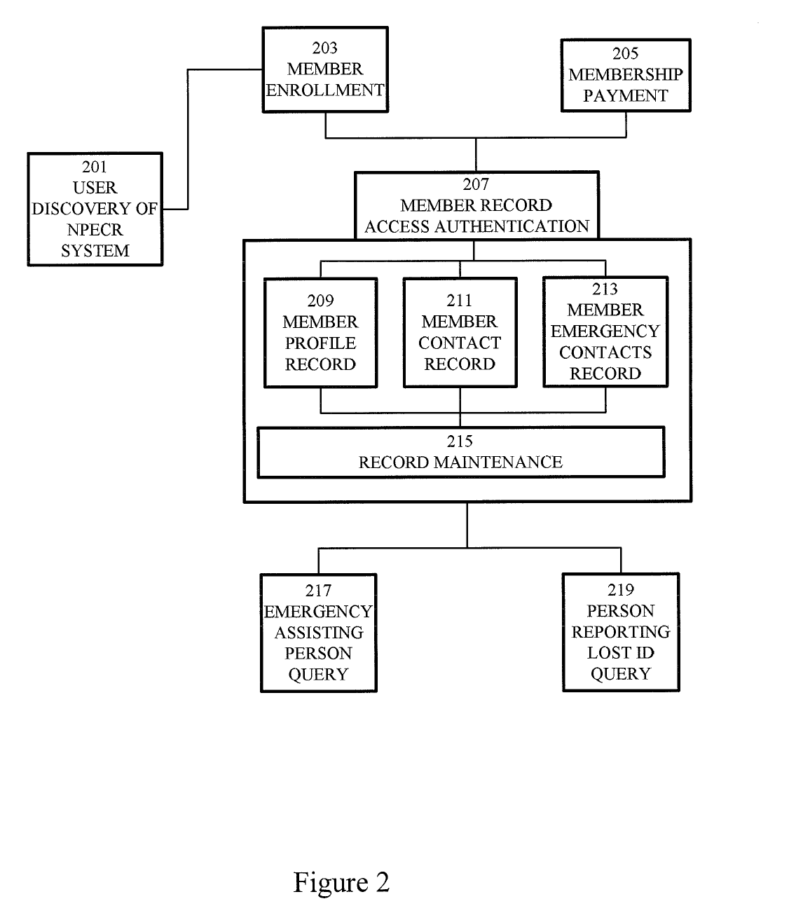

As shown in FIG. 2, the NPECR System features and characteristics provide a means for discovery of the product/system (201), Membership Enrollment (203), means for Membership Payment (205), Establishing a Member Record with role defined Access Authentication (207), Establishing a Member Profile Record (209), Establishing a Member Contact Record (211), Establishing Emergency Contacts Record (213), Performing Member Record Maintenance & Member Record Printing (215), Providing Emergency Assisting Person query (217), and Providing Perison Reporting Lost ID query (219).

The completeness of a Member Record may be either partial or whole depending upon the status of the data being provided by the Member (complete or incomplete state) as the Member desires or knows. The entire content of the Member's information contained within the NPECR System is referred to as the Members' Record (207). There are three main subsets of records within the Members' Record:
1. The Member Profile Record (209)
2. The Member Contact Record (211)
3. The Member Emergency Contacts Record (213).

A User of the NPECR system is any person, group, or entity that may make an inquisitive exploratory discovery of the NPECR System, be a Member, be a sponsor or designated point of contact for the Member [i.e. family member, employer, enrollment sponsor, other], an Emergency-Assisting-Person (E-A-P) (defined herein as any User that may be providing assistance to a Member during a time of need [i e, not limited to EMS]), or a Person-Reporting-Lost ID (P-R-L-ID) (defined herein as any User that wants to make contact with a Member to advise such member of a found ID).

NPECR System designers, developers, administrators, inspectors & auditors, operations support personnel, legal authorities, and vested owners are grouped as non-public domain Users. These are trusted persons who have a legitimate business need to access the System and/or its data. Their access rights are governed by the nature of their business responsibilities, the system design, and operations events.

There are five categories of public domain Users defined within the system external to the system administrators: 1) person making inquisitive inquiryy; 2) NPECR System Member, 3) Emergency-Assisting-Person; 4) Person-Reporting-Lost-ID; and 5) Person designated by a Member as a Member-Point-of-Contact. Based on these roles, access to the NPECR System and its features is role-based authenticated; these authentication procedures are described below and shown in Table 1.

The Person/User making Inquisitive Inquiry accesses the public pages of the system. He/she is on an exploratory search, discovering the system's existence, and assessing the value in enrolling. This User may be referred to as the general public. The general public has access to only that information available on the homepage not requiring NPECR System login authentication. This User cannot access any Members Record or data nor can they post any data without first completing Member Enrollment.

A Member is a User who has successfully enrolled in the NPECR System. There are two types of Members: Members with a personal email address and Members without a personal email address, Members without an email address or Members who have sponsors managing their enrollment, may choose to designate a third party's email address to receive select NPECR System generated notices for advising the Member. This designated third party may be referred to as Member-Point-of-Contact. The Member voluntarily provides all Member identification and contact data contained in the Record. The Member is responsible for the data's completeness, accuracy, currency, and disclosure. The Member proactively controls access or views of select data via maintenance of their Membership status, login authentication credentials, their Key Code, and respective disclosure of such. A Member must provide the appropriate login Member ID and Member established password in order to access their Member Record. Only an authenticated Member may modify any Members information posted in the NPECR System. The Member has full Member Record update, view, and print function capabilities.

An Emergency-Assisting-Person (E-A-P) is a User who is offering or providing emergency assistance to a Member. The E-A-P User may have only “view-and-print” capability of a Member's Emergency Contacts Record. The E-A-P may access said record by providing the Member's ID, origin of ID (e.g., issuing state driver's license, organization issuing ID, etc), and Key Code at time of NPECR System login. The Member's “Key Code” is a NPECR System generated code unique to that record and is appended to the Members Profile. The Member may make the Key Code apparent to other Users by transcribing it onto a means for providing this notification, such as a transparent sleeve or sticker on the Member's ID or an equivalent display. Because the Key Code is physically connected to an ID the Member values and requires for another, everyday purpose (e.g., driving), it is less likely to be lost or misplaced than a CD or medical alert device. The Key Code, which shall be considered equivalent to a unique password or personal identification number (PIN) is needed for access authentication for a non-member accessing targeted member data A Person-Reporting-Lost-ID (P-R-L-ID) is an individual who has found a Members' ID, wallet, purse, or similar, and wants to make contact with the Member for purpose of returning the artifacts. The P-R-L-ID User may have only view and print capability of the Member's Contact Record, or may also have access to the Member's Emergency Contact Record if the Member has not made such records inactive and has not changed its Key Code. The P-R-L-ID user accesses the said record by providing the Member's ID, ID origin, and Key Code at time of NPECR System login.

A Member-Point-of-Contact does not have inherent access to any of the Member's Record. The Member defines a Member's Member-Point-of-Contact role.

TABLE 1
Role Access Authentication

| | Authentication | | |
|---|---|---|---|
| User Role | Needed | Information available to user | User can Perform |
| Inquisitive | None | NPECR Home Page | General browsing |
| Query | | Information about NPECR | Membership Enrollment |
| | | Links to other informative websites | |
| Member | Member ID which | NPECR Home Page, | General browsing, Edit/Update |
| | equates to Login ID | Members Record: Member Profile Record, | Personal Profile, Post/Edit/Update |
| | and Member | Member Contact Record & Emergency | Emergency Contacts Record, |
| | established unique | Contacts Record, | Post/Edit/Update Member Contact |
| | password | NPECR Systems and features | Record, Print Membership ID, Request |
| | | | KEY CODE change, Change |
| | | | Password, Print Member Record, |
| | | | Renew Membership. |
| E-A-P | Member's ID number | NPECR Home Page | Request Member Emergency Contacts |
| | that serves as Login | E-A-P query request page | Record. May initiate emails to |
| | ID, Issue Origin, and | E-A-P query response page | emergency contacts system provided |
| | Member's Key Code | Member Emergency Contacts Record | email addresses. Only view and print |
| | that serves as needed | | NPECR System response. |
| | password. | | |
| P-R-L-ID | Member's ID number | NPECR Home Page | Request a Members Contact Record |
| | that servies as Login | P-R-L-ID query request page | Request members Emergency Contacts |
| | ID, Issue Origin, and | P-R-L-ID query response page | Record Only view and print NPECR |
| | Member's Key Code | Member Contact Record | System response. May initiate email to |
| | that serves as needed | | Member at system provided email |
| | password | | address. |
| Member | None - intrinsically | NPECR System generated email | Receives NPECR System notice in |
| Point-of- | does not access the | communications. | lieu of the Member. Does not |
| Contact | NPECR System | | intrinsically have access to any |
| | | | Members data or NPECR Systems |

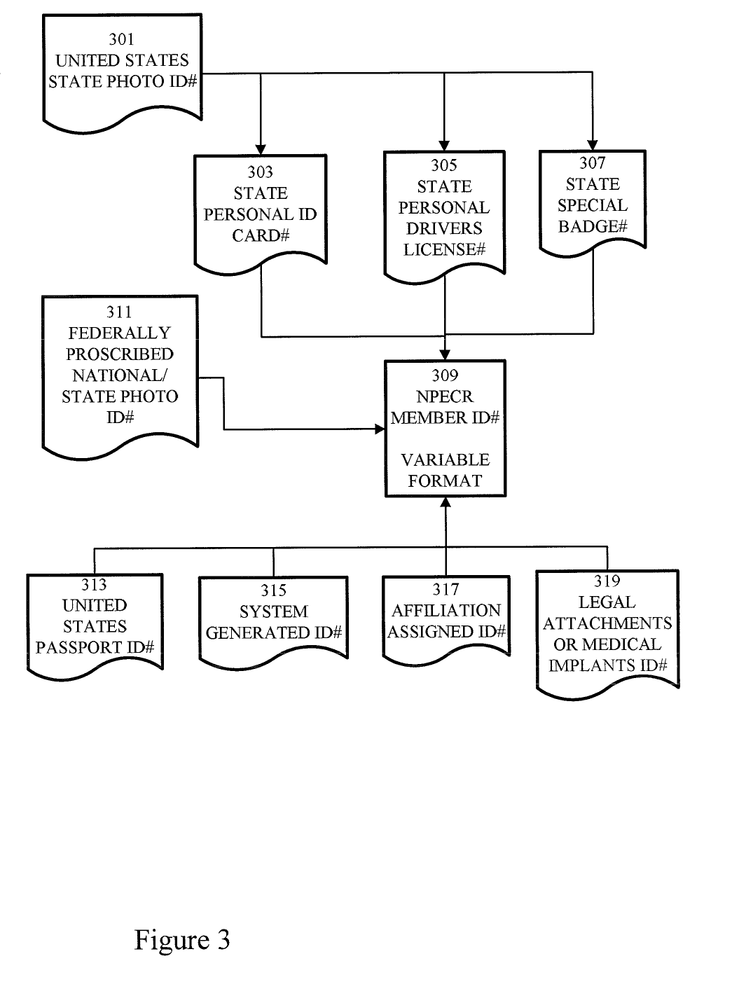

As diagrammed in FIG. 3, a subscribing Member voluntarily establishes his/her Member identification number during the enrollment process and whose record is indexed and controlled by such. An acceptable Member ID source, agency, format, method, and form is governed by the NPECR System and it's defined processing prerequisites. The acceptable form or format may vary over time as sponsors, affiliations, or agencies change their practices or as technology offerings advance in development.

The acceptable identification number generally is derived from a state or federal government-issued identification card issued for a secondary purpose (e.g., driver's license, passport, voter registration identification, or any sort of comprehensive government identification program). The system is intended to provide a preferred option for providing critical and accurate information at time-of-need for a person requiring emergency assistance of a mass target population. A substantial majority of the world population carries some sort of government-issued identification, such as a driver's license, passport, or other systematic government identification. Even more individuals carry identification for some other entity, such as insurance or automobile club membership. For example, at the end of 2007, there were believed to be more than 190 million state issued drivers licensees in the US; between 1997 and 2006 there are believed to have been over 79 million US passports issued; American Association of Retired People (AARP) has a membership that exceeds 38 million, and Blue Cross Blue Shield services more than 99 million members. Each of these identified members of the population carries an ID with a unique identifying number that serves a secondary purpose (e.g. driving, crossing international boundaries, acquiring insurance or automobile club membership benefits) that make the individual reluctant to lose the card. Because such a card is automatically issued by a different entity to an individual, and is less likely to be lost than a card solely for the purpose of providing emergency contact information, it is therefore desirable for an emergency contact system to interface with such a government-issued identification card. By including system recognized organizations, affiliations, or emerging technologies in unique individual identification and recognition forms, membership in such a system could expand to the US population at large, which is presently believed to be in excess of 300 million.

The type of card may vary over the life of the NPECR System. Specifically, the government-issued identification card may be, by way of non-limiting example, any United States or State issued identification form (301) including: State issued Personal Identification Number (303), State issued Drivers License Number (305), State issued Special Badge Identification Number (307) herein referred as State ID#, any other state-issued identification number, future federally proscribed unique Identification Number (311) of like intended use, a United States Passport ID# (313), a unique NPECR System generated number (315), a nationally recognized organization or affiliation Member ID (317), a legally attached device ID# or medically implanted ID# (319), or any other unique numeric identifier is also contemplated.

Herein any one such number or combination of such numbers is collectively defined as the NPECR Members Identification Number (309). Herein, Members Identification Number, Member ID Number, Member ID, Member, # and Member ID# are synonymous in definition and meaning. Member ID format may vary and may be composed from alpha characters, numeric characters, special characters, blanks, or any combination or variation thereof, in any order and whose length may be from 1 to infinity as controlled by the issuing entity (309). To serve as a valid source for a NPECR System Member ID, the ID form must be legally issued by a third party agency/organization, verifiable, current, include the subject's photo, and contain a unique and non-repeating numbering schema. The NPECR System may define and restrict what constitutes an appropriate Member ID source. United States Postal Service codes for states and U S territories may be incorporated into the Member ID, in order to identify the issuing state or entity, differentiate duplicated numbers issued by different sources, or any other reason.

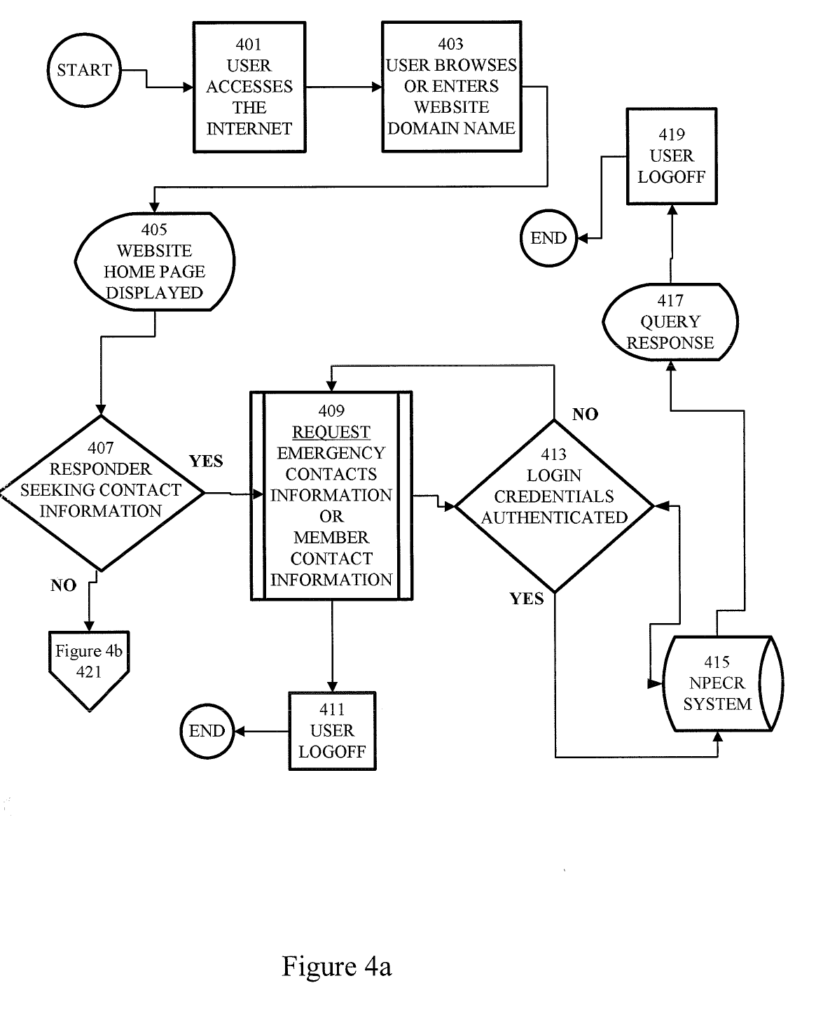

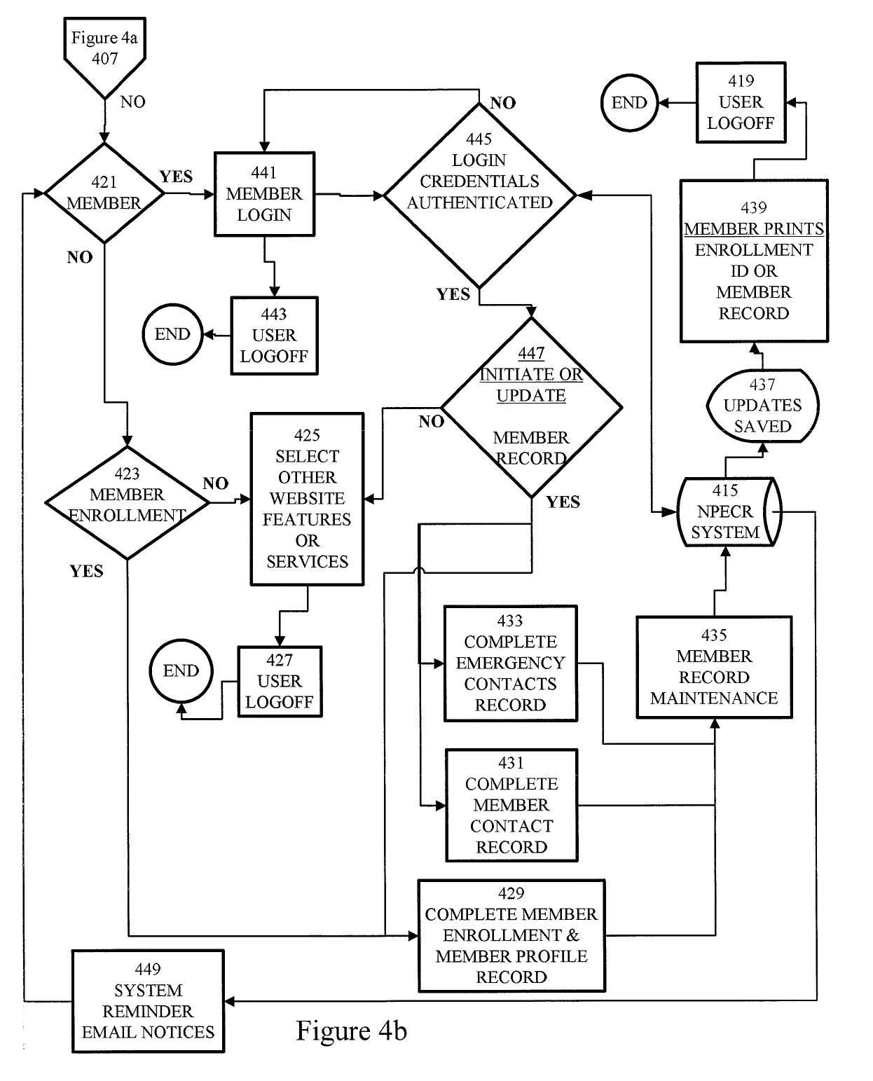

FIGS. 4A and 4B diagram embodiments of NPECR processes. In order to take advantage of the features of the NPECR System, a User and Member (or Member-Point-of-Contact) must have Internet access, as by use of personally owned computing devices; use of affiliate computing devices such as employers, acquaintances, sponsors; or use of public services such as libraries, educational institutions, or pay-by-use business sources (401). Not personally owning computing equipment nor subscribing to an Internet Service Provider (ISP) preempts a person from enrolling in the NPECR System.

Upon securing internet connectivity a User may access the NPECR System by using available internet browser search engines (403), i.e. Google, Yahoo, Explorer, AOL, etc, Key words or phases such as: 911 emergency contacts, personal emergency contacts, family contacts, lost drivers license, 911 friends contacts, contact registry, 911, family alert, family notification, emergency preparedness, emergency planning, medical emergency, medical alert, and others will yield a “hit” to the NPECR System. Key word search will return an extensive listing of subject responses and their respective topic URL or domain name the user may select and be directed to the desired website page or topic content. A matching hit of a key word to the NPECR System content may return website links (e.g., [URL domain name] such as, but not limited to, 911FamilyFriendsContacts.com, 911FriendsFamilyContacts.com, 911FamilyContacts.com, 911FamilyFriends.com, 911FriendsContacts.com, or any variation thereof (403). The NPECR System domain names are subject to change over the life of the system.

A User already familiar with the NPECR System domain name either by previous discovery, advertising disclosure, referral, Member enrollment, or using a Members ID and Key Code, may access the system by entering a URL domain name noted above or those in service at the time of use (403) When the website link responds, the User will be directed to the NPECR System Homepage (405).

If the User is a person providing emergency assistance to a Member (an Emergency-Assisting-Person) or has found a Member's ID (a Person-Reporting-Lost-ID) the User will identify that they were seeking to obtain contact information of a Member (407). The User will be directed to a screen to request the respective Record they want to retrieve, such as a Member's Emergency Contacts Record or Member Contact Record. The User will then be required to enter the prescribed unique Member Record access authentication information (409) according to the User's role. The NPECR System will then authenticate the information provided during login with that information on file (415).

If the provided information does not match that which is on file (413) the User will be referred back to the request screen to try again (409). The User may also choose to logoff the system (411). If the provided information matches that which is on file (413) the System will respond by providing a view of the requested record (417). Following any respective System response, the User is expected to logoff the system and ends this user 's session (419).

If the User chooses to enter the system (407) and is a NPECR Member (421), he/she will be required to enter the proscribed unique Member login credentials (441). The NPECR System will then authenticate the information provided during login with that information on file (445). If the login information does not match that which is on file (415) the User will be referred back to the login screen to try again (441). The User may at any time elect to logoff the system (443).

If the Member login information (441) does match that which is on file (415) the Member determines if he/she desires to access their Member Record to initiate or update record information (447). If they do not want to access their Member Record (447) they will be directed to other website features or information (425) and then logoff the system ending their user's session (427).

If the Member wants to initiate or update their record (447) the system will direct them to the member action screen where they may select:: update Member Profile Record (429), initiate/update Member Contact Record (431) or initiate/update Member Emergency Contacts Record (433). The Member performs their desired actions, confirms and saves their changes (437) and may print a copy of their enrollment ID or a copy of their complete Member Record information (439). Any of these actions constitute performing Member Record Maintenance and provide the basis for the NPECR System tracking of a member's status and record changes (435). The Member would then logoff the NPECR System (419).

If a User chooses to enter the system (407) and is not a Member (421) yet does not elect to enroll (423) they may select other selected website features or material for viewing that may assist them in determining their interest (425). The User may at any time elect to logoff the system (427) ending the users session. Other selected website features and or linked URLs may vary over the life of the system.

If a User chooses to enter the system (407), is not a Member (419), and selects Member Enrollment (423) the system will direct them to the Member Enrollment Processing (429). Following successful Member Enrollment (429) the Member may continue to complete the Member Contact Record (431) and/or complete the Member Emergency Contacts Record (433) processes or elect to complete those processes at a later time. Either way, the Member performs their desired actions, confirms and saves their postings (437) establishing a baseline Member Record for future maintenance (435), and may print a copy of their enrollment ID or a copy of their complete Member Record information (439). The Member would then logoff the NPECR System (419) ending the users session.

The Member Profile Record, Member Contact Record, and Member Emergency Contacts Record collectively constitute the Member Record. Once a Member Profile Record has been established (429) the state of the Member Record is dynamic and may vary in contents based upon Member Maintenance discipline (435). To encourage Members to keep their Member Record information up to date the NPECR System (415) may periodically send update reminder notices to Members (449). The Member would subsequently login to the NPECR System (403) advance to Member Login (441) and proceed accordingly to make any necessary updates to their Member Record.

A Member Record under the NPECR System voluntarily established, maintained, and controlled by the Member and may exist in either partial or complete form in the system. A record is that information or data that is both member provided or system generated information and is indexed or appended to the Members ID#. A record may be in either electronic or hard copy form and its collective contents are referred to as the Member's Record, A Members ID# and the Member Record has a one to one correlation. A Member Record is established once the Member ID# is saved in the NPECR System and a Key Code has been system generated resulting from successful Membership Enrollment.

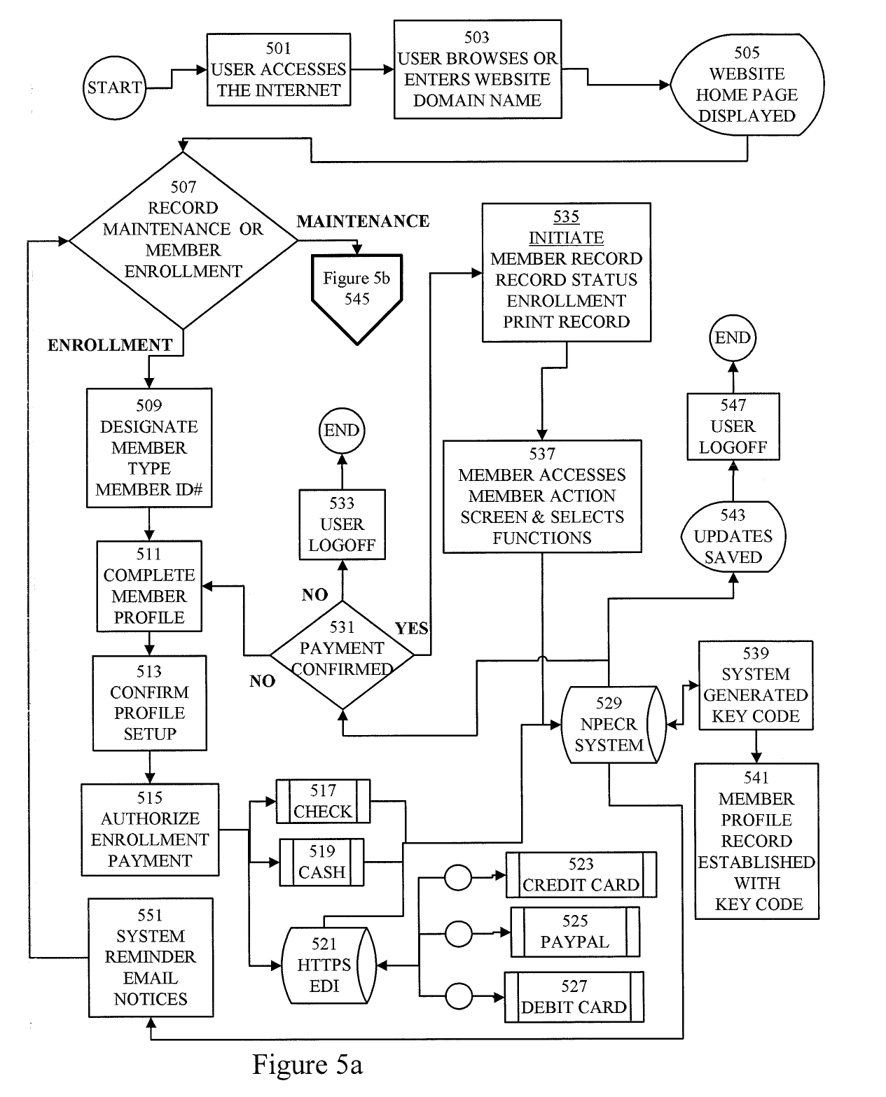

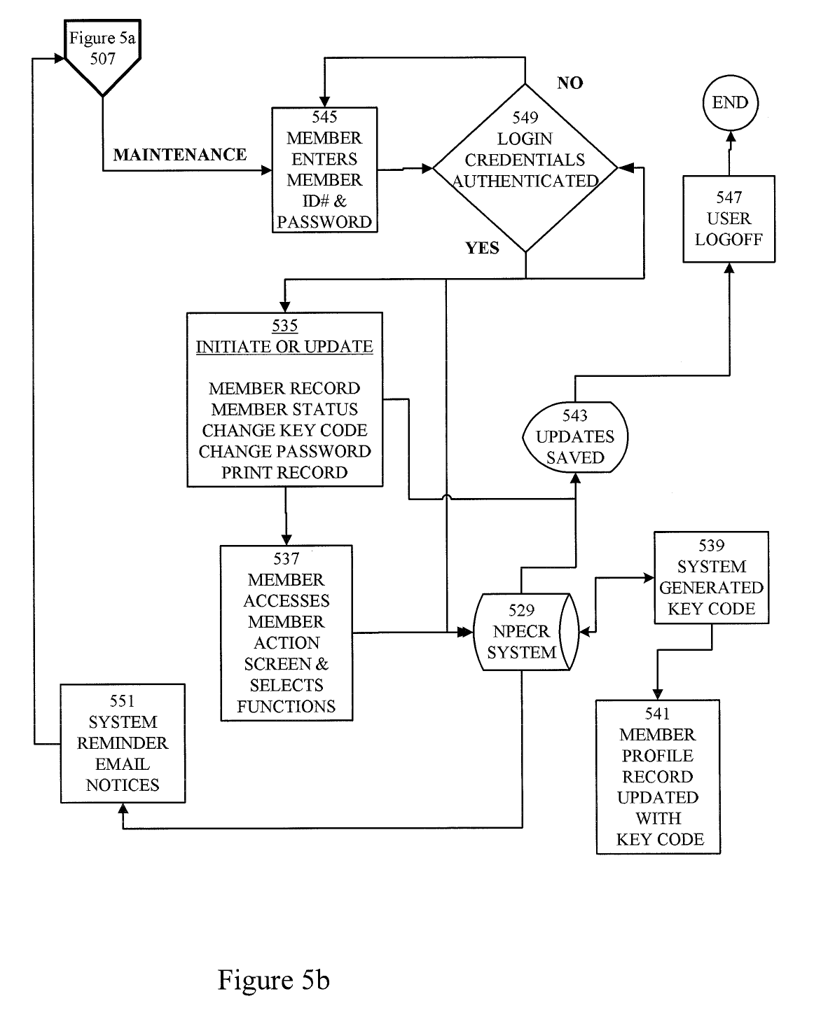

FIGS. 5A and B show embodiments of enrollment processes and creation of a Member profile Record. A Member may have only one active Member ID# or one inactive Member ID# on file at any one time. A Member may change or make their Member Contact Record and/or their Emergency Contacts Record inactive at any time without affecting the status of their Member ID#.

At the Homepage the User will have the choice of selecting “Member” for those already established Members wanting to complete or update record information, or “Member Enrollment” for those wanting to initiate the enrollment processes (507).

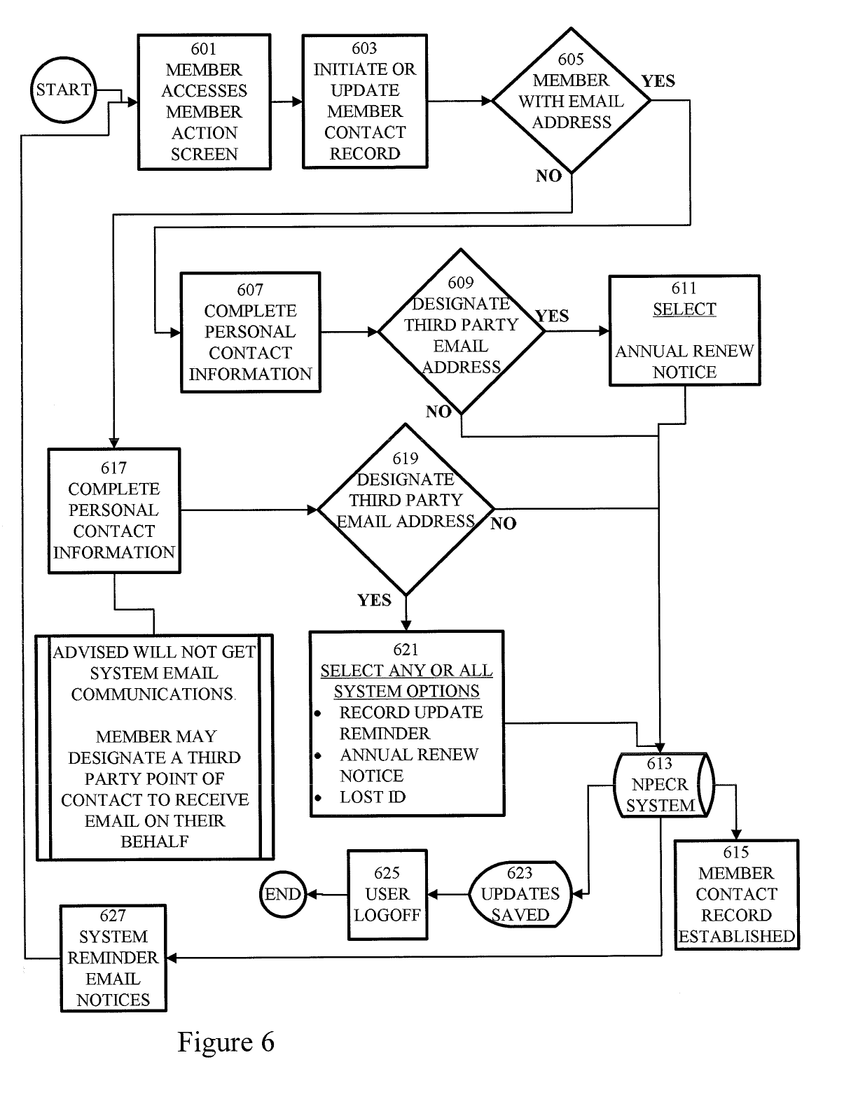

Upon selecting Member Enrollment, the User will need to confirm their Member Type (509). There are two Member Types. A user may enroll as a Member with a personal email address (personal or affiliate/association assigned personal account such as employer, agencies, organizations or clubs). Alternatively, a User may enroll as a Member without a personal email address. Members without an email address have all the same benefits and features as a Member with an email address except they will not be able to receive NPECR System email correspondence directly. However, they may designate another individual to receive the NPECR System email correspondence on their behalf during the Member Record setup processes address in FIG. 6 Member Contact Record (619). After designating the Member Type, the User must then provide Official ID# for purpose of establishing their NPECR System Member ID# The Official ID# is the government identification number on the government-issued identification with which the Member wishes the System to interface. The Member Profile is thereby indexed to the User-provided Official ID# which is now their Member ID#.

The User proceeds with completing the Member Profile (511). A Member Profile Record contains that information voluntarily provided by the Member that is needed to establish enrollment and the system generated Key Code. It includes information that may be viewed or accessed by the Member only and requires login credentials be authenticated using the Member ID and Member established password. The Member may update any portion of their Member Record at any time including changing password, requesting a new Key Code, or the status of their enrollment. Member Profile Record includes a unique user password that must meet the system defined criteria and security question/response selection for password reset. The combination of the Member's login ID and unique password constitutes the Member's login authentication criteria. It is the uniqueness and confidentiality of the combination of the Member ID as the system login ID and the Member defined password that limits the selection and viewing of the Member's Record or subcomponents of the Members Record. The Member ID coupled with the Member unique password provides the Member future access to the Members Record. It also includes the origin of Official ID# issued which will be selected from system defined dropdown options (i.e. U.S. State, Agency Name, Organization Name, other) in order to aid in record indexing and data storage/retrieval efficiency. Third, it includes their full name for Member identity confirmation during communications. Finally, it includes the member mailing address for official membership mailing purposes.

A Member's enrollment password must be unique and meet the system defined criteria at time of origination. It is the uniqueness between the password and the Key Code that distinguishes roles of Users and what parts of a Members Record is accessible. It is the variability of the Key Code that is managed by the Member that maintains controlled access to limited parts of a Member Record on a need-to-know basis.

The User next must confirm (513) the contents and accuracy of the information posted to the NPECR System Member Profile setup or make any necessary corrections before continuing the enrollment processes. The User must now authorize enrollment payment (515). Payment methods may include any of the following but not limited to: processing a check through a designated receiving center (517), payment by cash via an authorized custodian (519), internet electronic payment through a secure electronic data interface (521) for select services such as direct credit card charge (523), PayPal confirmed payment (525), or debit card transaction (527).

If payment receipt can not be confirmed (531) through the NPECR System (529) the User will be directed back to (511) Complete Member Profile, and elect to complete the processing again or abandon the enrollment process and logoff the system (533), ending the User's session.

If enrollment payment is confirmed (531) the User's Member Profile is saved (543) and concurrently, the NPECR System will generate a unique Key Code comprising of a combination of alpha and numeric characters randomly generated according to the system design (539). The length of the Key Code and the Member's view as to the length of the Key Code may vary from a minimum of six characters to an infinite defined limit. This unique aspect of the system assures that the Key Code is unpredictable in structure and values precluding unauthorized discovery through random data intrusion or intentional unauthorized access attempts to access the record using more predictable code devised schemes.

Once the Key Code has been generated it is appended to the Member ID# and the User is at this time becomes a NPECR System enrolled Member (541). The Member Record now comprises of a Member Profile with a Key Code. The Member may at any time and as often as he/she chooses request a new Key Code be system generated through the Member action processes (537).

Once a Member Record with a Member Profile has been established (541) the Member may proceed with completing the Member Contact Record and/or the Member Emergency Contacts Record by going to the Member action screen (537) and selecting the respective function he/she desires to perform. The Member may also elect to return to the system at a later date to perform such and logoff the system (547) ending the user's session.

A Member already familiar with the NPECR System domain name may access the system by entering the URL domain name in service at the time of use (503). The Member will be directed to the NPECR System Homepage (505). At the Homepage the Member will choose (507) Member, in order to complete or update record information. The Member will enter his/her Member ID# and NPECR System password (529). If the login credentials are not authenticated (549) with the information on file the Member will be directed back to reenter the information (545). If the member has forgotten their password he/she may request a password be reset by initiating such request from the website Homepage. A one-time use password will be sent to the Member's email address as reflected in their Member Profile. Once logged in under the one-time use password the Member will be required to establish a new personal password. If login credentials cannot be authenticated access to Members Records will be denied.

If the login credentials are authenticated (549) with the information on file (529) the Member will be able to initiate or update (535) the contents of the Member Record by accessing the member action screen (537) and selecting the respective function he/she desires to perform. The Member saves desired updates (543), may print their Member Record (535) or log off the system (547) ending the user's session.

A Member returning to the system and wanting to initiate or update (535) any portion of his/her Member Record information, change the Member Record accessibility status, renew enrollment, or print his/her record may do so as needed. System reminder notices (551) will be generated to remind the Member to periodically review the completeness and currency of his/her Member Record and their Member Enrollment status.

FIG. 6 shows an embodiment for the setup of a Member Contact Record. A Member Contact Record contains that information voluntarily provided by the Member relating to the Members' personal phone numbers and/or email addresses for display to a Per-son-Reporting-Lost-ID query/request for Member Contact information. The NPECR System uses the Member's first email address on record for communications unless a third party designated Member.-Point-of-Contact has been indicated. Only the Member may modify the record and requires login credentials be authenticated using the Member ID and Member established password.

The Member Contact Record is created by a Member having successfully logged into the NPECR System and going to the member action screen (601). He/she would then select the initiate or update member contact record option (603). The Member would indicate if the Member has a personal email address account (605). The email account must be a person-specific account and unique to the Member. It may be a personally obtained email address or an email address provided by an employer or other affiliation. If the Member indicates yes to an email account he/she will proceed to post their personal contact information to the system (607). The Member Contact Record contains key but limited information and is used to provide another party just enough information to be able to contact a Member to advise the Member that they have the Member's ID in hand. The Member Record may include the Members phone numbers and email addresses or any less amount of information (i.e., just phone number or just e-mail). A feature of the system for a found Member ID is to direct all communications from that party to the Member.

Another feature is to allow for another party to monitor payment enrollment status for a Member such as a guardian or organization enrollment sponsors (609). If a Member selects yes to designating another person's email address as that of a Member-Point-of-Contact they may choose to designate a party to receive NPECR System generated email notices concerning annual membership renewal (611). Other e-mail addresses or Member-points-of-contact options may be defined over the life of the system. The member posts the respective third party email address information for notification of Membership Enrollment status. The Member-Point-of-Contact does not have inherent access to the Member's Record and must coordinate Member Enrollment updates with the Member. The Member Point-of-Contact would be responsible to advise the Member of any email correspondence. All other email communications are channeled directly to the Member's email addresses.

If the Member chooses to not designate a third party email address (609) or has completed the designation of a third party Member Point-of-Contact (611) the record is captured by NPECR System (613), saved by the Member (623), and the Member Contact Record is established (615). The Member may logoff of the system (625). The NPECR System may generate periodic reminder notices to Members advising them to review their record status (627). It is up to the Member to keep their information current in the system.

If a Member indicates he/she does not have a personal email account (605) he/she will proceed to post their personal contact information to the system (617). The Member Contact Record contains key but limited information and is used to provide another party just enough information to be able to contact a Member and advise the Member that they have the Member's ID in hand. The Member Contact Record may contain the Members phone numbers, and may or may not include a Member-Point-of-Contact email address.

Based upon the Member indicating he/she does not have a personal email account for directly receiving any email correspondence a system message will advise that as a feature of the system they have an option to designate a third party email address as a Member-Point-of-Contact. If a Member selects yes (619) to designating another persons email address as a point of contact, based upon system defined selection options in effect at the time, they may choose to designate that party to receive NPECR System generated email notices (621) such as: record update reminders, annual renew notice, lost ID email message, or any combination. Other options may be defined over the life of the system. The member posts the respective third party email address information. The Member-Point-of-Contact does not have inherent access to the Members Record. The Member-Point-of-Contact would be responsible to advise the Member of any email correspondence.

If the Member chooses to not designate a third party email address (619) or has completed the designation of a third party point of contact (621) the record is captured by NPECR System (613) saved by the Member (623) and the Member Contact Record is established (615). The Member may logoff of the system (625). The NPECR System generates periodic reminder notices to Members-Point-of-Contacts advising them to have the Member review their record status (627). It is up to the Member to keep their information current in the system.

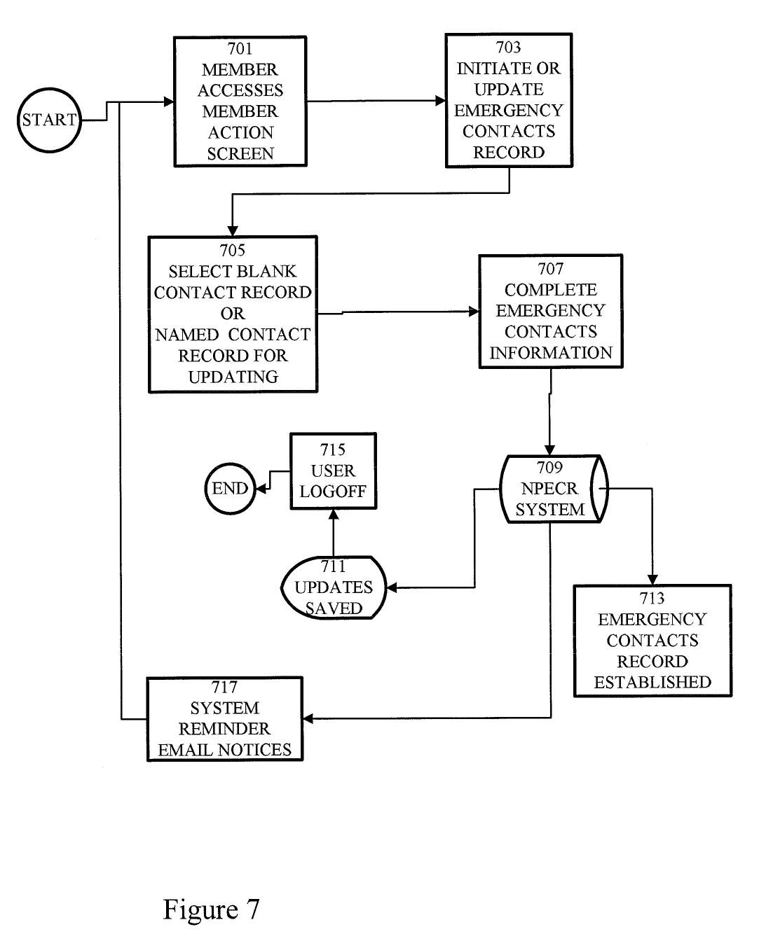

FIG. 7 shows an embodiment of a setup of a Member Emergency Contacts Record. An embodiment of a Member Emergency Contacts Record contains information voluntarily provided by the Member that identifies the person or per'sons that should be contacted at time of personal emergency. It is the responsibility of the Member to advise personal emergency contacts of their designation. The Emergency Contracts Record includes: priority, names, phone numbers and email addresses for display or printing when responding to an Emergency-Assisting-Person query. Only the Member may modify the record and requires login credentials be authenticated using the Member ID and Member established password.

The Member Emergency Contacts Record is created by a Member having successfully logged into the NPECR System and going to the member action screen (701). He/she would then select the initiate or update member emergency contacts record option (703). The NPECR System displays the number of emergency contacts that may be posted to the system. The number of emergency contacts posted to the system may vary over the life of the system. The presence or absence of information is evident by a name being displayed in a box or the box is blank. The Member selects a blank box to initially post a contact's information or selects a box with a given name if the Member intends to update the posted information that may also include deleting any previously posted information (705). After selecting a specific contact record, the Member may update or complete the emergency contact information record providing: person's common name (how they should be addressed during communications), phone numbers, and email addresses (707). The order of the boxes indicates the priority or sequence in how their information is displayed in response to a system query. The record is captured by NPECR System (709) and is saved by the Member (711). The Member Emergency Contacts Record is established (713). The Member may logoff of the system (715). The NPECR System generates periodic reminder notices to Members advising them to review their record status (717). It is up to the Member to keep their information current in the system.

At any time a Member realizes they have lost their Member ID they may access the NPECR System and make either/both their Member Contact Record or Emergency Contacts Record inactive. If the Member keeps his/her Member Record active this allows for the P-R-L-ID person to obtain the Members Contact Record without exposing access to the Emergency Contact Record. Otherwise, the Member may request a change in Key Code (eliminating any party accessing any record with the obsolete Key Code). Should the Member obtain a replacement Member ID#, they would access the NPECR System and establish a new Member Record and Member Profile accordingly.

The NPECR System facilitates anyone, anywhere, at any time, to obtain contact information from a Members Contact Record or Members Emergency Contacts Record providing they have the necessary access authentication criteria and access to the Internet (directly or indirectly). There are two categories of persons that may have a need to access the contact information for a Member or Members emergency contacts. Emergency Assisting Person(s) [E-A-P] and Person Reporting Lost ID [P-R-L-ID]. Examples of these types of persons include: Emergency Medical Services, hospitals, police, doctors'/dentists' offices, school/university administration, employers/coworkers, family members, neighbors/friends, Good Samaritans, highway assistance, or other persons involved in an emergency.

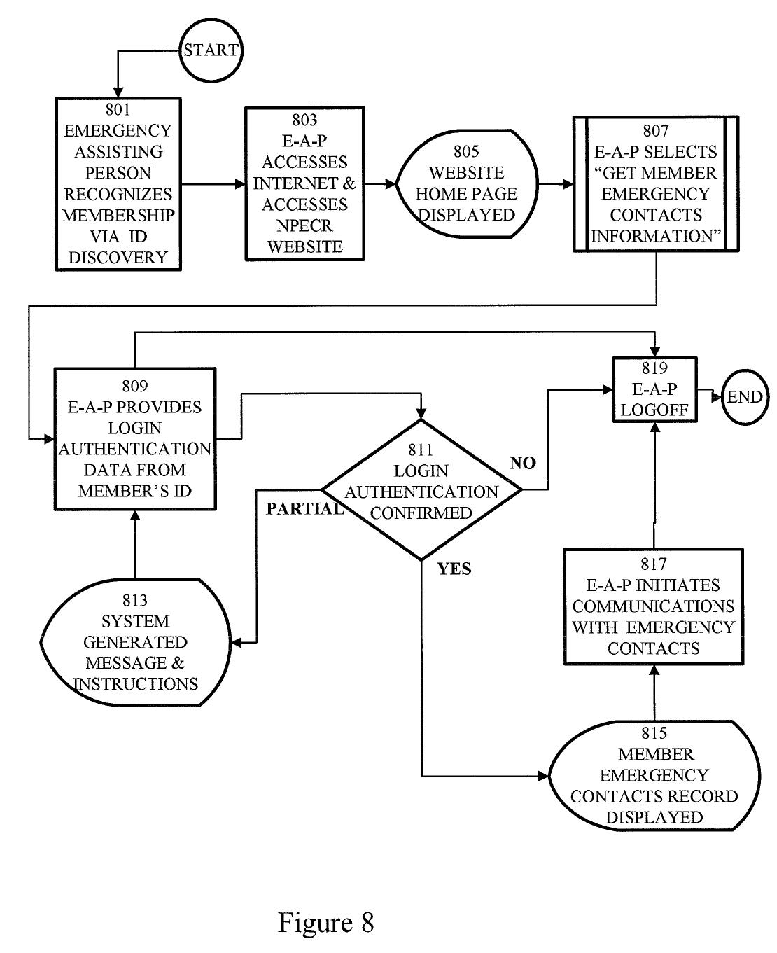

FIG. 8 shows an embodiment of how an emergency assisting person may query the system. Under a multitude of scenarios, a person or persons may be providing or coordinating emergency care services to a Member who is unable to effectively communicate at the time of need either due to unconsciousness, incoherency or language barriers. Such person or persons are herein referred to as an Emergency-Assisting-Person (E-A-P). By the E-A-P searching for identification and locating a Members ID, they may readily recognize that the individual is a Member of the NPECR System. The E-A-P has in hand the Members' ID by virtue of an officially issued personal ID [which is also the NPECR System Login ID for an E-A-P], can identify the ID's issuing agency of origin, and has the Member's annotated Key Code on the ID sleeve or insert card. With the necessary information in hand: the ID number, issuing origin, and unique NPECR System generated Key Code, the person has the necessary credentials for access authentication and requesting the Members Emergency Contacts Record. E-A-P would not have access to the Member's Profile Record nor be able to modify any information on file. An E-A-P may immediately and directly access the Members' Emergency Contacts Record via any device that has Internet access with alpha/numeric input and read/view display or print features. Should the E-A-P only have a mobile/cell phone they may relay the necessary information to another party with Internet access to perform the query. The E-A-P may then communicate directly with the designated emergency contact obtaining any array of needed/relevant information pertaining to care or wishes. The E-A-P may also elect to send a discrete email message to all emergency contacts' respective email addresses posted in the NPECR system advising them of the circumstances.

Following the successful recovery of an emergency situation, the Member could access the NPECR system and request a change in Key Code thus precluding any person from making a future inappropriate query for personal contacts information on record. The record remains only accessible at time of need and with necessary disclosure of the Key Code.

During the course of responding to the need for emergency services care an E-A-P person may discover the Members enrollment in the NPECR System (801). In an embodiment, the Member's ID sleeve may provide the website and directive to access and obtain emergency contact information. The E-A-P obtains directly or via another party, Internet connectivity and accesses the NPECR System (803). The NPECR System website homepage is displayed (805). From the homepage, an E-A-P selects “get member emergency contacts information” (807). The system may prompt the E-A-P to provide: Member ID#, issuing origin, and the unique member Key Code (809).

If the provided login information is only partially authenticated (one or more of the three elements match) with the information in the NPECR System (811) the system will generate a message with instructions to confirm the accuracy of the entries (813). The E-A-P may reenter or choose to abandon the request and logoff (819).

If the provided login information cannot be authenticated (811) (no elements match) the E-A-P is informed of no record match and E-A-P logs off the system (819). Once a Member's enrollment expires, all information is purged from the system, also resulting in a no record match message.

If the provided login information is authenticated (811) the Members Emergency Contacts Record is displayed (815) providing the E-A-P with the phone numbers and/or email addresses for emergency contacts entered by the Member. The information may remain in view, be noted or printed and the E-A-P logoff (819).

The E-A-P may immediately initiate communications directly with the Member's emergency contacts, disclose the situation, obtain information and coordinate services (817).

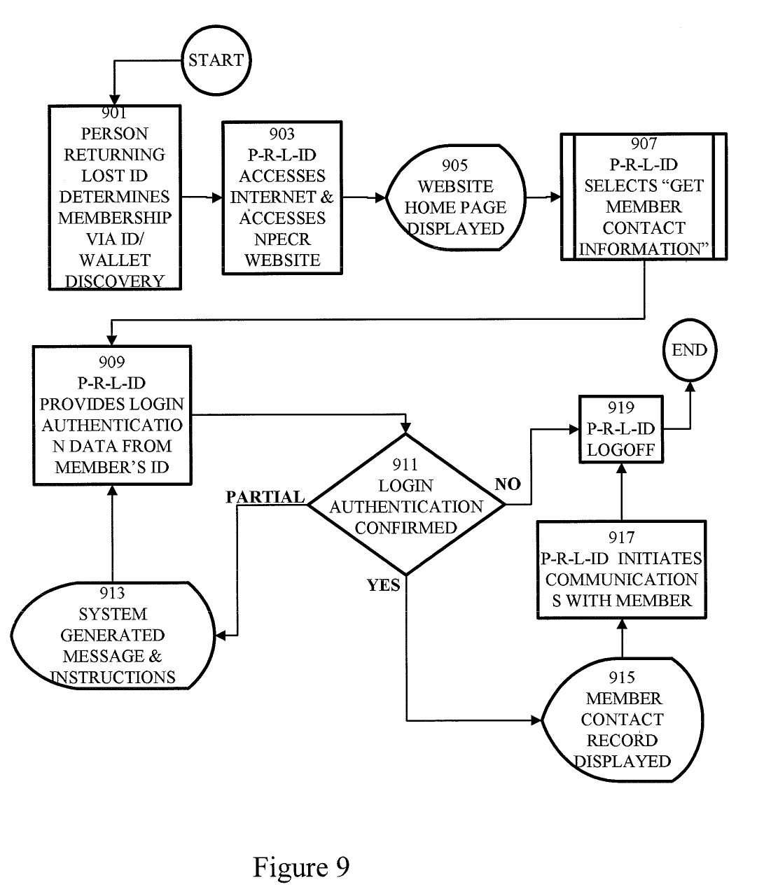

FIG. 9 shows an embodiment of how a Per-son Reporting Lost ID (P-R-L-ID) may query the system. In the event a Members ID (source ID) is lost and subsequently found by a person wanting to return it, the Member ID would provide the P-R-L-ID with the instructions and information necessary to obtain contact information via the NPECR system. The P-R-L-ID may have found just the ID or also the Member's wallet, purse, backpack, or other carrier of the ID. The P-R-L-ID discovers the Members participation in the NPECR system, in am embodiment by the Key Code or other notation on the ID sleeve. In an embodiment, the notation directs the P-R-L-ID to go to the system website if the ID is found. By virtue of having the Source ID and the Members Key Code, the P-R-L-ID may login to the NPECR system, indicate their query as a P-R-L-ID, and obtain the Member's Contact Record, via any device that has internet access with alpha/numeric input and read/view display features. Should the P-R-L-ID only have a mobile/cell phone they may relay the necessary information to another party to perform the query. The P-R-L-ID does not see a Members address nor can they modify any information in the record.

The P-R-L-ID obtains access to the Internet and accesses the NPECR website (903). The website homepage is displayed (905). From the homepage options the P-R-L-ID selects get member contact information (907). The system prompts the PRLID to provide login authentication data that is evident on the Member's ID (909) including: Member ID#, issuing origin, and Members unique Key Code.

If the provided login information is only partially authenticated (one or more of the three elements match) with the information in the NPECR System (911) the system will generate a message with instructions to confirm the accuracy of the entries (913). The P-R-L-ID may reenter or choose to abandon the request and logoff (919).

If the provided login information cannot be authenticated (911) (no elements match) the P-R-L-ID is informed and would elect to logoff the system (919). Once a Members enrollment expires, all information is purged from the system that may result in a no record match message.

If the provided login information is authenticated (911) the Member Contact Record is displayed (915) providing the P-R-L-ID with the phone numbers and/or email address provided by the Member for either the Member or the Member-Point-of-Contact. The information may remain in view or be noted and the PRLID logoff (919).

The P-R-L-ID may immediately initiate communications directly with the Member or Member's point of contact to advise them of the found ID and make arrangements for its timely return (917). The P-R-L-ID may then communicates directly with the Member obtaining instructions. Following the successful return of the ID, the Member would preferably access the NPECR System and request a change in Key Code thus precluding any person from making a future inappropriate query for information on record. The record remains only accessible at time of need, with Member ID in hand, and knowledge of the current Key Code.

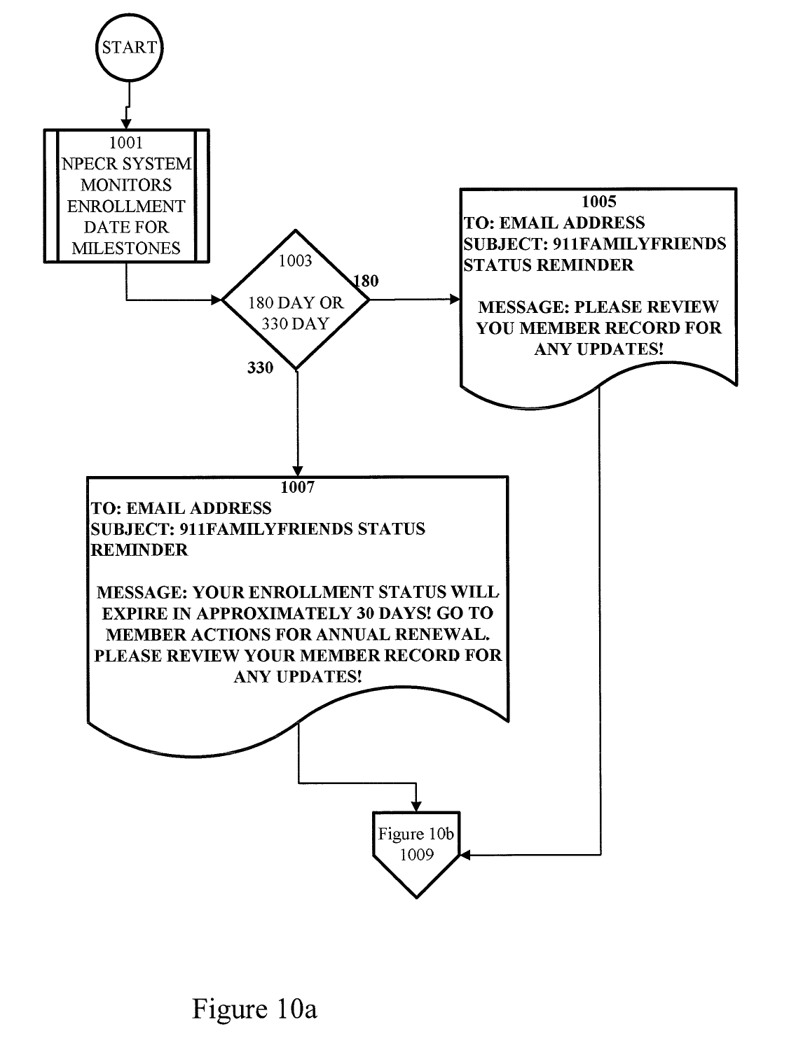

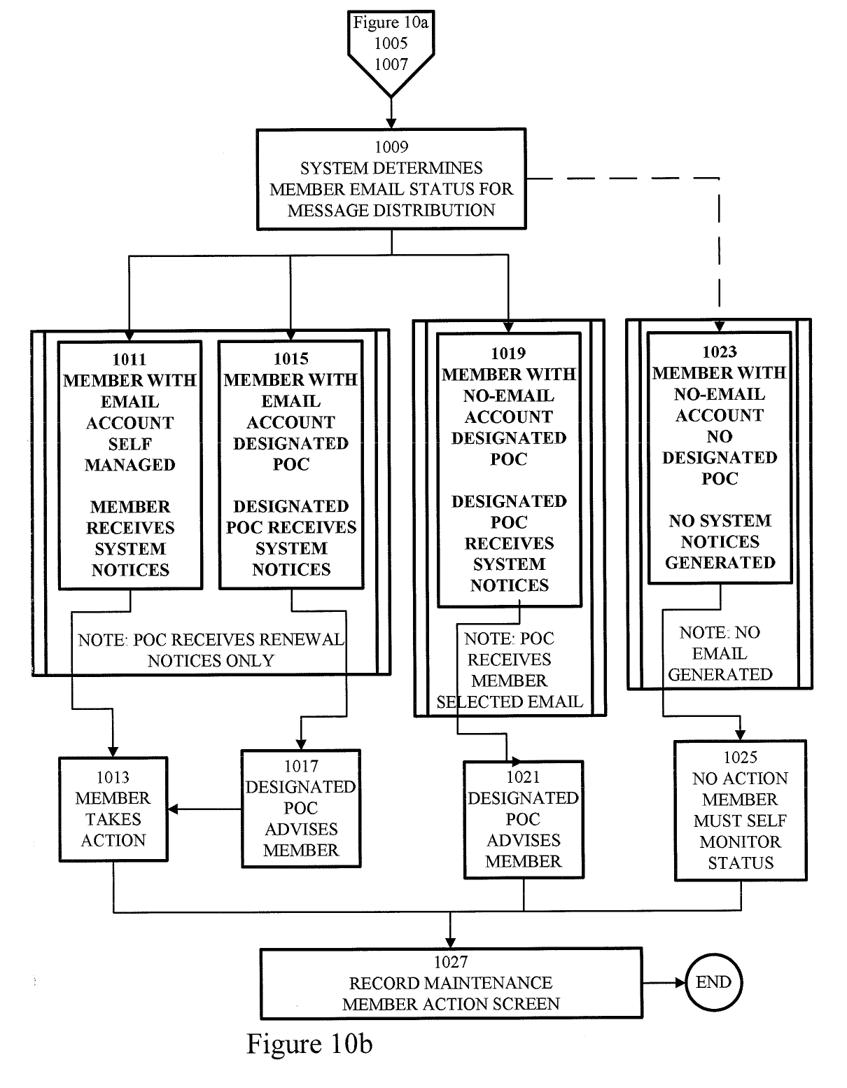

FIGS. 10A and B show embodiments of how a Member may update their Member Profile, Member Contact Record, or Emergency Contact information. The Member provides all data on file; it is up to the Member to keep it current. A Member Record may be updated any time, continuously, from any location using any device that can provide the needed system connectivity. The record may be updated as often as needed in order to keep the Member Record current. The Member may routinely update any record contents by accessing the member action screen and selecting the respective function.

To assist and encourage record maintenance the NPECR System may periodically generate email reminder notices based on the enrollment date reflected in the Member's Profile Record. The notices may include but may not be limited to: a reminder to Members to review the status of their Member Record and make any necessary updates; or a reminder to Members that their enrollment is about to expire. The email notices will be sent to the first email address reflected in the Members Contact Record or a third party Member-Point-of-Contact email address as designated in the Members Contact Record.

The NPECR System may track the Member's enrollment date for key milestones (1001) that may vary over the life of the system. Preferably, the NPECR System assists the Member in maintaining their record current and continuity in service. In an embodiment, at approximately 180 days following Member enrollment date (1003) the NPECR System may generate an email addressed to the designated email address to advise the Member to review their Member Record for any updates (1005). And at approximately 330 days following Member enrollment date (1003) the NPECR System may generate an email addressed to the designed email address to advise the Member that the should renew their enrollment (1007) and at the same time review their Member Record for any updates. The NPECR System determines the email address to be used based upon the Member Type and email address designation established in the Member Contact Record (1009).

If Member Type is Member-with-email account and no third party designated point-of-contact the review Member Record email and the renew enrollment email will be sent to the Member email address on record (1011). The Member would initiate their respective record maintenance actions (1013).

If Member Type is Member-with-email account and has a designated third party point-of-contact the review Member Record email would be sent to the Member email address of record. The renew enrollment email will be sent to both the Member and the third party Member-Point-of-Contact (1015). The designated point-of-contact would coordinate respective record maintenance actions through the Member (1017).

If the Member Type is Member-with-no-email account and has designated a third party Member-Point-of-Contact the Member selected email categories will be sent to the designated point-of-contact email address of record (1019). The designated point-of-contact would advise and coordinate respective record maintenance actions through the Member (1021).

If the Member Type is Member-with-no-email account and has not designated a third party point-of-contact no emails will be generated by the System (1023). It will be the sole responsibility of the Member to monitor their Member Record Status (1025).

The Member would initiate the desired Record Maintenance actions by logging into the NPECR System, accessing the Member action screen, and selecting the respective Member action (1027).

To recognize the NPECR system benefits, a comparative baseline perspective is necessary. First, it is an extreme minority of persons that carry any form of record on them that provides identification of persons to contact at time of emergency care. This may be attributed to inattentiveness, cumbersome mechanics, or deficiencies in the alternatives to the NPECR system. Second, the most fundamental alternative, a hand written note, becomes obsolete the moment written and stowed. Notes may not be readily recognized by E-A-P which may result in the misdirection of effort by the E-A-P providing care. Third, an alternative method may be dependent upon a third party agent (e g. call enter employee) who may miscommunicate information. Forth, a dependant deciphering media device (e.g., CD-drive or card reader) may not be readily available to the E-A-P. And fifth, people are lax in updating records due to forgetfulness or inconvenience.

The following examples are only a few of many that reflect situations where the NPECR system may provide timely, accurate, multiple contacts and multiple means for communicating with emergency contacts at time of need, and demonstrates it's superiority over alternate approaches.

### EXAMPLE 1

Tim lived in North Carolina and was on business travel in California. He was returning to his hotel from a late personal dinner engagement via taxi. He was alone and his cell phone battery was dead. The taxi was involved in an accident. Tim and the taxi driver were seriously injured and both were unconscious. EMS (herein referred to E-A-P) arrived, took Tim's vital signs and stabilized Tim. EAP searched for identification and located his wallet and immediately turned to Tim's North Carolina State Drivers License. In doing such the EAP discovered his membership in NPECR System. The EAP utilized his mobile unit laptop, accessed the internet, entered the website domain (that was printed on Tim's license sleeve) in the URL bar, clicked on one icon, entered three data elements present on Tim's license and received five contact names each with up to three phone numbers and/or two email addresses. EAP recognized that it was 1:32 a.m. in California. He chose to call the first contact at the home phone number but also had the choice of work or cell numbers. Tim's wife answered and a brief dialogue transpired between she and the EAP, which included a summary of Tim's medical history. Tim's wife advised EAP that Tim was allergic to aspirin based medications. Tim's wife was now aware of his condition, was advised where he was being transported to, and was able to advise other persons and make necessary plans. The whole process from the time of discovery of Tim's NPECR System membership to direct communications' engagement with Tim's wife, and collaboration on case management took less than 2 minutes to initiate and was concluded with timely and critical notification/counsel.

### EXAMPLE 2

Marshall, an employee of ABC Company for 17 years, was participating in a management meeting with his boss Robert in a conference room at his company's corporate office. Little more than a year earlier Marshall's wife passed away. Just a week earlier Marshall moved from his large home of 11 years into a smaller patio home in a remote but local area. Marshall suddenly passed out during the meeting. Another meeting participant immediately called EMS and Robert immediately contacted his administrator and Human Resources asking for Marshall's emergency contact information on record with ABC. Robert was advised that ABC's emergency contact record still reflected Marshall's wife as person to contact, an old phone number, and Marshall's previous address. Marshall's ABC record had not been updated in over 10 years. [Similar circumstances would exist if the employer's office was closed, thus making employee records unavailable.] EMS (herein referred to E-A-P) arrived, took Marshall's vital signs and stabilized Marshall. EAP searched for identification, located his wallet and immediately turned to Marshall's State Drivers License. In doing such the EAP discovered his membership in NPECR System. The EAP shared the discovery with Robert. Robert immediately used a computer station in the conference room accessed the internet, entered the website domain (that was printed on Marshall's license sleeve) in the URL bar, clicked on one icon, entered three data elements present on Marshall's license and received five contact names each with up to three phone numbers and/or two email addresses. Robert printed the record and provided it to the EAP. The EAP took Marshal and the printout to his transport. While in transport the EAP called Leon, the first name on record on the cell number provided by NPECR System. Leon, Marshall's stepson (different last name) answered the call. Leon advised EAP of Marshall's spousal loss and recent home move that was both emotional and physically demanding, and that Marshall had been maintaining high levels of stress and just yesterday started taking medication for depression. Leon was now aware of Marshall's condition, advised where he was being transported to, and was able to advise other persons and make necessary plans. The whole process from the time of discovery of Marshall's NPECR System membership to direct communications' engagement with Leon, and collaboration on case management took less than 2 minutes to initiate and concluded with timely and critical notification/counsel.

### EXAMPLE 3

Emily was found unconscious in her car at roadside by the State Highway Patrol at 9:15 am. EMS was dispatched, arrived, and immediately transported Emily to the local hospital emergency room. During admission, her insurance card, State Drivers License, business cards and other personal articles were found in her purse. The admission agent Sally recognized Emily's membership in NPECR System. Sally was familiar with NPECR System and in fact was a member as well. Sally promptly went to her computer, accessed the internet, entered the website domain (that was printed on Emily's license sleeve) in the URL bar, clicked on one icon, entered three data elements present on Emily's license and received five contact names, each with up to three phone numbers and/or two email addresses. Sally printed the record. Sally proceeded to make contact with Barbara the first name on the record. She called the home number (only one provided for this contact) and got no answer but left a brief/generic message on the answer machine for Barbara to return the call. Next Sally sent a similarly brief/generic email to Barbara's email address indicated on the record. It turned out that Emily's house mate Barbara is on business travel. Sally next went to the second name Carol and called her work number and reached Carol. Carol was Emily's sister. Carol indicated that she spoke with Emily that morning and that Emily had a bad pain in her lower back and was on her way to her doctor's office. Carol was now aware of Emily's condition, aware of her location, and was able to advise other persons (i.e., track down Barbara) and make necessary plans. The whole process from the time of emergency room arrival, discovery of Emily's NPECR System membership, to direct communications' engagement with Carol, and collaboration on case management took less than 10 minutes to initiate and concluded with timely and critical notification/counsel.

### EXAMPLE 4

Larry lived alone, was retired, had no surviving family members, and lived a very secluded life style. Larry was having chest pains and called 911 from his home. Larry went unconscious while on the phone call. EMS arrived, provided treatment but determined Larry had passed. Law enforcement arrived (Detective Fred) and searched for Larry's identification and relevant personal information. Meanwhile, Larry was being transported to the medial examiners office. Fred located Larry's wallet on the bedroom dresser. Fred pulled Larry's State Driver's license and noted his membership in the NPECR System. Upon return to his office, Fred went to his computer, accessed the internet, entered the website domain (that was printed on Larry's license sleeve) in the URL bar, clicked on one icon, entered three data elements present on Larry's license and received five contact names each with up to three phone numbers and/or two email addresses. Fred correlated that the only number associated with the first name was the same as Larry's home phone and was likely a previous house mate. Fred initiated a call to the second point of contact Mike. Fred called Mike's office number but got no answer. Fred then reached Mike at the provided home number. It turned out, that day offices were closed due to a major snowstorm so Mike was at home. It took Fred less than 15 minutes of effort to advise Mike of the circumstances. Mike was able to timely advise others and make the necessary arrangements. Mike was the executor for Larry's estate.

### EXAMPLE 5

Tim and Mary were U.S. citizens and on an extended vacation in Europe. They were on a personal hiking excursion and both were seriously injured. They were transported to emergency services. They were both sedated for treatment and expected to make a full recovery. Meanwhile, the admissions agent Robert obtained their passports and personal articles for follow-up notification. While perusing Tim's wallet Robert noted Tim's membership in the NPECR System. Robert (in Europe) went to his computer, accessed the internet (WWW), entered the website domain (that was printed on Tim's license sleeve) in the URL bart, clicked on one icon, entered three data elements present on Tim's license, and received five contact names each with up to three phone numbers and/or two email addresses. Robert noticed that the first emergency contact person was each other's respectively. Robert initiated a brief and discrete email to all emergency contacts listed email addresses requesting he be called. Within 5 minutes Doug (their son-in-law), the emergency contact forth in order, which received the email on his blackberry, contacted Robert. Doug was advised of the circumstances. Doug agreed to advise others, coordinated arrangements and got back to Robert within 4 hours. With less than 10 minutes of effort and less than 15 minutes lapsed time Robert was able to consummate international contact with Tim and Mary's designated per-sons to contact at time of an emergency.

### EXAMPLE 6

Jose was a young Hispanic who resided in Carlsbad, Calif. and spoke very poor and limited English. Jose was traveling through a remote urban area in Nebraska when he became seriously ill. Jose went to a local medical clinic seeking help. The clinic had minimal staff on duty at the time. Jose, the clinic admission agent Betty, and the resident physician Karen were unable to effectively commutate due to language barriers. Furthermore, there were no persons present that could speak Spanish and provide assistance. Betty initiated a page to a clinic staff member who can eventually resolve the communications issue. Meanwhile, Jose presented his California drivers license and displayed his NPECR System membership. Betty went to her computers, accessed the internet, entered the website domain (that was printed on Jose's license sleeve) in the URL bar, clicked on one icon, entered three data elements present on Jose's license and received five contact names each with up to three phone numbers and/or two email addresses. Betty called the first contact name (Esther) at home. Esther spoke good English and Betty described the circumstances. Esther served as a translator providing Betty & Karen with the information they needed to document symptoms, assess urgency, and continue admittance. Jose's condition was stabilized. One hour later the clinic staff member who spoke limited Spanish arrived. With less than 10 minutes of effort Betty was able to independently obtain a strangers' trusted emergency contact that could resolve a language communications barrier resulting in prompt medical treatment,

### EXAMPLE 7

Russ sold his home and moved his home goods to storage two weeks ago in Florida, and was in process of moving to Virginia in conjunction with an employment change. Russ and his wife were residing in a corporate extended stay facility for approximately 3 more weeks until they could move into their new residence. Russ had updated his NPECR System profile with current personal phone numbers and email addresses immediately following the sale of their home. Russ's address on his license was obsolete, his old home phone number was disconnected, and he had a new work number. Russ had been at the airport returning form a business trip that morning and his wife had picked him up and dropped him off at the office around 10:30 a.m. Around 11:00 a m. an airport porter turned Russ's billfold over to Airport Security Officer Ward. Ward when inventorying Russ's billfold noticed Russ's membership in NPECR System indicating “IF FOUND, go to website . . . ” Ward went to his computer, accessed the internet, entered the website domain (that was printed on Russ's license sleeve) in the URL bar, clicked on one icon, entered three data elements present on Russ's license, and received Russ's name, three phone numbers and two email addresses for Russ. Around 11:30 a.m. Russ got a call on his personal cell phone from airport Security Officer Ward. The officer queried Russ about his identification, place of residence, credit cards and business cards and if Russ had his billfold (which he normally stowed in his coat pocket now hanging on his office door). Russ confirmed he didn't know where the billfold was and Ward confirmed it had been turned into the airport security office about an hour earlier. Russ made arrangements to get to the airport before the end of Ward's shift, collected his billfold and thanked Officer Ward. Ward confided that it normally would take many days before a lost billfold and its contents might be returned to the rightful owner and in this case would have been sent to Florida. With 10 minutes of effort by Officer Ward and the information made available by NPECR System the billfold was returned the same day it was lost.

### EXAMPLE 8

George was a South Carolina resident on travel in Germany and was providing two weeks of company critical consulting services to a local business. In the afternoon of day two George discovered he lost his wallet that contained his ID, cash, traveler's checks, credit cards, some key business cards, and other, George was frantic and immediately called his wife and work office in the US to advise them of his predicament and seeking advice. Earlier, a local restaurateur Hans, whose establishment was on the walking path between George's hotel and his clients' office, found his wallet on the sidewalk. Hans found the NPECR System membership instruction appended to George's Drivers License indicating” IF FOUND, go to website . . . ”. Hans went to his computer, accessed the internet (WWW), entered the website domain (that is printed on George's license sleeve) in the URL bar, clicked on one icon, entered three data elements on George's license and received George's name, three phone numbers and two email addresses. Hans immediately sent an email to the two email addresses for George provided by NPECR System. George soon got an email on his blackberry saying “I have your wallet call my restaurant at . . . ). George made arrangement to meet the proprietor at 6:00 p.m. recovered his wallet (only the cash was missing), thanked Hans, and treated two of his clients to dinner at the establishment. With less than 5 minutes of effort by Hans, George's wallet was returned to him within hours while on foreign travel with minimal inconvenience. He at least avoided not seeing his driver's license and credit cards for weeks pending mailing to his license address or ultimately avoided the hassle of obtaining a driver's license and credit cards replacement following his return to the US.

### EXAMPLE 9

Mike and Donna were on vacation visiting Donna's parents Fred and Irene in Delaware. They consciously left Mike's cell phone, blackberry and laptop at home since essential parties knew their itinerary and had no plans of doing any work. Around 10:15 p.m. Sunday Irene answered a phone call and then indicated to Mike he should take it. Mike was queried by a hospital administrator Brenda in Atlanta Ga. if his daughters' name was Ashley, some other personal attributes and if she played for a prominent university women's soccer team in North Carolina. Mike confirmed affirmatively and was then advised that the team bus had been in a serious accident around 9:00 p.m. returning from a Florida competition. Ashley was incoherent during EMS transport, was currently under sedation but had stabilized. Mike and Donna made plans to immediately leave for Atlanta. The admissions administrator Brenda had recognized Ashley's membership to NPECR System when admitting her. Brenda went to her computer, accessed the internet, entered the website domain (that was printed on Ashley's license sleeve) in the URL bar, clicked on one icon, entered three data elements on Ashley's license and received five contact names each with up to three phone numbers and/or two email addresses. Brenda called the three phone numbers for the first two contacts that were Mike and Donna. Having failed in making contact Brenda started calling the third contact that was Grandma Irene who was able to locate Mike and Donna. With about 30 minutes of effort Brenda was able to confirm notification to Ashley's parents about an incident that they would have heard on the 11:00 p.m. news, would have unlikely been able to be contacted timely by other means and avoided the means of uncertainty as to both location and condition of their daughter.

1. A method for providing contact information in the event of an emergency or lost identification, said method comprising:
issuing a government-issued identification card, comprising a government identification number, to an individual for a secondary purpose;
said individual enrolling in a registry as a member, said step of enrolling comprising:
providing said contact information, further comprising a profile, contact record, and emergency contact record;
providing said government identification number; and
creating a password,
generating a key code associated with said password upon said enrollment;
generating a member identification number associated with said government identification number upon said enrollment,
displaying said key code on said card,
authenticating a user to obtain said member's contact information based on said user's role and said user's correct entry into said registry of said member's key code and information on said card; and
providing said contact information to said user.

2. The method of claim 1 wherein said step of displaying utilizes a transparent sleeve for said card.

3. The method of claim 1 wherein said enrolling comprises paying an enrollment fee.

4. The method of claim 3 further comprising reminding said member to pay said enmollment fee's next installment.

5. The method of claim 1 further comprising reminding said member to update said contact information.

6. The method of claim 1 wherein said information on said card comprises the name of said member, the origin of said card, and said member identification number.

7. The method of claim 1 wherein said steps of enrolling, generating, authenticating, and providing all use the internet.

8. The method of claim 1 wherein said card is a state-issued driver's license.

9. The method of claim 1 wherein said card is a passport.

10. The method of claim 1 wherein said user is an emergency assisting person, and wherein said contact information in said step of providing is limited to said emergency contact record.

11. The method of claim 1 wherein said user is a person reporting lost ID, and wherein said contact information in said step of providing is limited to said contact record.

12. The method of claim 1 wherein said contact information comprises a member point of contact.

13. The method of claim 1 wherein said user is said member, wherein upon said step of authenticating further comprising entering said password into said registry, said user may update said contact information.

14. A system for providing contact information in the event of an emergency or lost identification, said system comprising:
a government-issued identification card, comprising a government identification number, coupled to means for providing notification of enrollment in said system;
an online registry wherein an individual enrolls by entering a profile, said identification number, contact record, and emergency contact record, and creating a password, and wherein upon said enrollment said registry issues said individual a key code corresponding to said password and a member identification number corresponding to said government identification number;
wherein said key code is placed upon said means for providing notification, and
wherein a user authenticated by said registry according to said user's role may access said individual's contact information by said key code, said member identification number, the name of said individual on said card, and the origin of said card.

15. The system of claim 14 wherein said registry reminds said individual to update said contact information.

16. The system of claim 14 wherein said means for providing notification comprises a transparent sleeve for said card.

17. The system of claim 14 wherein said individual enrolls by further paying an enrollment fee.

18. The system of claim 17 wherein said registry reminds said individual to pay said enrollment fee's next installment.

19. The system of claim 14 wherein said registry is on the internet and said enrolling, said authenticating, and said access utilize the internet.

20. The system of claim 14 wherein said card is a state-issued driver's license.

21. The system of claim 14 wherein said card is a passport.

22. The system of claim 14 wherein said user is an emergency assisting person, and wherein said user may access said individual's contact information limited to said emergency contact record.

23. The system of claim 14 wherein said user is a person reporting lost ID, and wherein said user may access said individual's contact information limited to said contact record.

24. The system of claim 14 wherein said contact information comprises a member point of contact.

25. The system of claim 14 wherein said user is said individual, and wherein said user may use said key code, said information on said card, and said password to access and update said individual's contact information.
